(19) United States
(12) Patent Application Publication
(10) Pub. No.: US 2009/0289562 A1
(43) Pub. Date: Nov. 26, 2009

(54) LIGHT-EMITTING APPARATUS AND DIMMING METHOD

(76) Inventor: Wen-Jyh SAH, Tainan City (TW)

Correspondence Address: BIRCH STEWART KOLASCH & BIRCH, PO BOX 747, FALLS CHURCH, VA, 22040-0747, US

(21) Appl. No.: 12/467,639

(22) Filed: May 18, 2009

(30) Foreign Application Priority Data
May 21, 2008 (TW) 097118675

(51) Int. Cl. H05B 37/02

(52) U.S. Cl. 315/209 R; 315/307

(57) ABSTRACT

A light-emitting apparatus applied with a power switch includes a light-emitting unit and a dimming driving unit. The light-emitting unit has at least one light-emitting element. The dimming driving unit is electrically connected with the light-emitting unit and controls the light-emitting element to emit a first brightness or a second brightness, which are both nonzero, according to a switching frequency or a switching interval of the power switch during a specific time range when the power switch is turned on.

### CROSS REFERENCE TO RELATED APPLICATIONS

This Non-provisional application claims priority under 35 U.S.C. §119(a) on Patent Application No(s). 097118675 filed in Taiwan, Republic of China on May 21, 2008, the entire contents of which are hereby incorporated by reference.

### BACKGROUND OF THE INVENTION

1. Field of Invention

The present invention relates to a light-emitting apparatus and a dimming method.

2. Related Art

The light-emitting apparatus is an essential device in modern life. It can be applied in various fields such as illumination and display. The light source of the light-emitting apparatus has been developed from, for example, the traditional incandescent lamp to the current fluorescent lamp and a significant improvement can be found in the luminous efficiency and lifespan of the current fluorescent lamp.

FIG. 1 illustrates a schematic view of the indoor illumination. As shown in FIG. 1, a light-emitting apparatus 1 that is disposed on the ceiling of a room has five light-emitting elements 11-15. A power switch S1 is on the wall of the room for controlling the power supply to the light-emitting elements 11-15 so as to control the light emission of the light-emitting elements. A user will need different brightness depending on different demands, hence in prior art, a different number of light-emitting elements are turned on to control the total brightness of the light-emitting apparatus 1. The operating steps are as follows: when the user turns on the power switch S1 for the first time, all light-emitting elements 11-15 are turned on. When the user turns off the power switch S1 and turns it on for the second time in a short period of time, only three light-emitting elements 11, 13, and 15 are turned on. When the user turns off the power switch S1 and turns it on for the third time in a short period of time, only the light-emitting element 12 is turned on. When the user turns off the power switch S1 and turns it on for the fourth time in a short period of time, all of the light-emitting elements 11-15 are turned on again.

As mentioned above, the user controls the brightness of the light-emitting apparatus 1 by controlling the light emission from different number of the light-emitting elements 11-15. However, the user cannot control the brightness of a single light-emitting element 11, 12, 13, 14, or 15 by the power switch S1. In addition, the light source in a conference room usually needs to be turned off while using a projector. But such light source is normally a plurality of light-emitting elements located at different areas in the room, so that the light-emitting elements are either all off or only some of them are on, such as the front half are off and the rest are on. This makes it difficult for the conference participants to view the projected image and take notes at the same time. Accordingly, it is important for the single light-emitting element to have the brightness control function.

Thus, it is an important subject to provide a light-emitting apparatus and dimming method that may control the brightness of a single light-emitting element by the power switch so that the light-emitting element can be conveniently used and its product competitiveness can be enhanced.

### SUMMARY OF THE INVENTION

In view of the foregoing, the present invention is to provide a light-emitting apparatus and a dimming method for controlling the brightness of a single light-emitting element by a power switch.

To achieve the above, a light-emitting apparatus of the present invention is applied with a power switch and includes a light-emitting unit and a dimming driving unit. The light-emitting unit has at least one light-emitting element. The dimming driving unit is electrically connected to the light-emitting unit and controls the light-emitting unit to emit a first brightness and a second brightness, which are both nonzero, according to a switching frequency or a switching interval during a specific time range when the power switch is turned on.

To achieve the above, another light-emitting apparatus of the present invention includes a light-emitting unit and a dimming driving unit. The light-emitting unit has at least one light-emitting element. The dimming driving unit is electrically connected to the light-emitting unit and controls the light emitting unit to emit a first brightness or a second brightness, which are both nonzero, according to a frequency or an interval of receiving an external power signal during a specific time range when the dimming driving unit receives the external power signal.

To achieve the above, a dimming method of the present invention includes the steps of electrically connecting a light-emitting unit and a dimming driving unit; and controlling the light-emitting element to emit a first brightness or a second brightness, which are both nonzero, according to a frequency or an interval of receiving an external power signal during a specific time range when the dimming driving unit receives the external power signal.

As described above, the light-emitting apparatus and the dimming method according to the present invention control the light-emitting element to emit a first brightness or a second brightness, which are both nonzero, according to a switching frequency or a switching interval of a power switch during a specific time range when the power switch is turned on. The light-emitting apparatus and the dimming method may also control the light-emitting element to emit a first brightness or a second brightness, which are both nonzero, according to a frequency or an interval of receiving an external power signal during a specific time range when the dimming driving unit receives the external power signal. Therefore, the light-emitting element may adjust the brightness of a single light-emitting element by emitting out different brightness, so as to be conveniently used and enhance product competitiveness.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional power switch applied with a light-emitting apparatus;

FIGS. 2 to 5 are block diagrams of a light-emitting apparatus according to a preferred embodiment of the present invention;

FIG. 6 is a flowchart of a dimming method according to a preferred embodiment of the present invention; and

FIGS. 7A to 7F are waveforms of different signals of a light-emitting apparatus according to a preferred embodiment of the present invention.

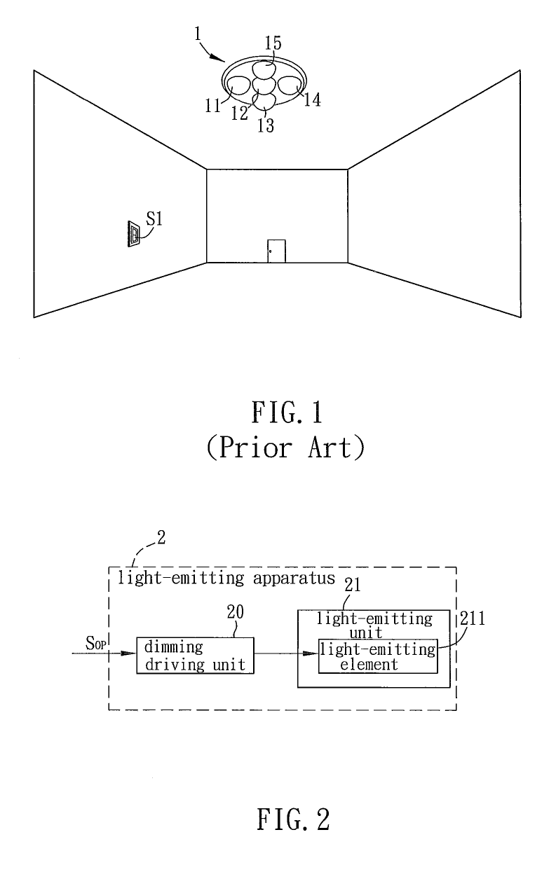

### DETAILED DESCRIPTION OF THE INVENTION

The present invention will be apparent from the following detailed description, which proceeds with reference to the accompanying drawings, wherein the same references relate to the same elements.

FIG. 2 is a block diagram of a light-emitting apparatus 2 according to a preferred embodiment of the present invention. With reference to FIG. 2, the light-emitting apparatus 2 includes a light-emitting unit 21 and a dimming driving unit 20.

The light-emitting unit 21 includes at least one light-emitting element 211, which may be a single airtight-packaged light-emitting unit. In the embodiment, the light-emitting element 211 may be a fluorescent lamp such as a cold cathode fluorescent lamp (CCFL), a hot cathode fluorescent lamp (HCFL), or an external electrode fluorescent lamp (EEFL). In addition, the light-emitting element 211 may be in various shapes, for example, spiral, linear, or in U-shape.

The dimming driving unit 20 is electrically connected to the light-emitting unit 21 and controls the light-emitting element 211 to emit a first brightness or a second brightness, which are both nonzero, according to a frequency or an interval of receiving an external power signal S_{OP} during a specific time range when the dimming driving unit 20 receives the external power signal S_{OP} It is noted that the frequency of receiving the external power signals S_{OP} is defined based on the times that a user switches on/off the light-emitting apparatus 2, and the interval of receiving the external power signals S_{OP} is defined based on the period of time that the user switches the light-emitting apparatus 2 twice.

In the present invention, the specific time range is not limited and may be set to, for example, less than or equal to 10 seconds depending on the user's habit and handiness. The specific time range may be determined in accordance with the circuit and the electronic element, for example, the charging time or the discharging time of one or more capacitors. In the embodiment, the external power signal S_{OP} is supplied by the external power supply, which also provides the energy for emitting the light-emitting element 211, for example, an alternating current (AC) power supply (e.g. the city power supply) or a direct current (DC) power supply (e.g. the solar energy).

The frequency of the external power signal S_{OP} received by the dimming driving unit 20 during a specific time range is namely the frequency of the external power signal S_{OP} transmitted intermittently to the dimming driving unit 20 during the specific time range. The external power signal S_{OP} may be intermittently transmitted to the dimming driving unit 20 by the electronic element, which may be a transistor, a power switch on the wall, or a remote control.

The interval of the external power signal S_{OP} received by the dimming driving unit 20 during a specific time range is namely the time between two or more transmissions of the external power signal S_{OP} during a specific time range. The time between the first transmission and the last transmission to the dimming driving unit 20 is the interval.

The dimming driving unit 20 may control the light-emitting element 211 to emit a first brightness or a second brightness, which are both nonzero, according to the frequency of receiving the external power signal S_{OP} during the specific time range when the dimming driving unit 20 receives the external power signal S_{OP}. For instance, when the specific time range is 3 seconds and if the dimming driving unit 20 receives the external power signal S_{OP} three times within 3 seconds, the light-emitting element 211 is controlled to emit the first brightness, e.g. one-third of the full brightness, as the external power signal S_{OP} is received for the third time; if the dimming driving unit 20 receives the external power signal S_{OP} five times within 3 seconds, the light-emitting element 211 is controlled to emit the second brightness, e.g. half of the full brightness, as the external power signal S_{OP} is received for the fifth time.

The dimming driving unit 20 may control the light-emitting element 211 to emit the first brightness or the second brightness according to the interval of receiving the external power signal S_{OP} during a specific time range when the dimming driving unit 20 receives the external power signal S_{OP}. For example, when the specific time range is 3 seconds and the interval is the time between two transmissions of the external power signal S_{OP} to the dimming driving unit 20, if the dimming driving unit 20 receives the external power signal S_{OP} twice within 3 seconds and the interval between the two transmissions is 1 second, the light-emitting element 211 is controlled to emit the first brightness, e.g. one-third of the full brightness, as the external power signal S_{OP} is received for the second time; if the dimming driving unit 20 receives the external power signal S_{OP} twice within 3 seconds and the interval between the two transmissions is 2 seconds, the light-emitting element 211 is controlled to emit the second brightness, e.g. half of the full brightness, as the external power signal S_{OP} is received for the second time.

As a matter of course, the above-mentioned frequencies, intervals, first brightness and the second brightness are disclosed as examples rather than limitations to the present invention.

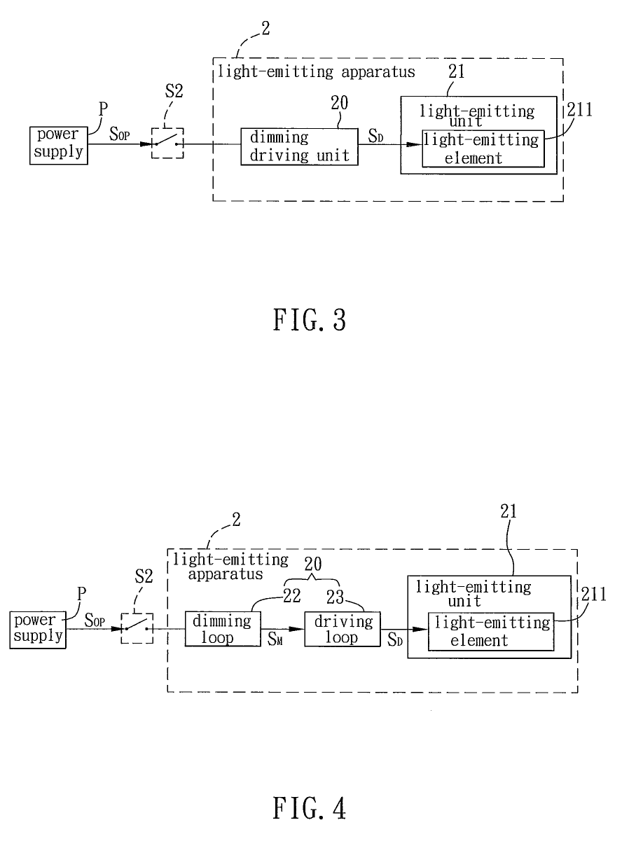

FIG. 3 is a block diagram of the light-emitting apparatus 2. As shown in FIG. 3, in the embodiment, the external power signal S_{OP} may be provided by a power supply P applied with a power switch S2. The power supply P may be an AC power supply (e.g. the city power supply) or a DC power supply. The power switch S2 electrically connects the dimming driving unit 20 with the power supply P for switching on or off between the power supply P and the dimming driving unit 20. When it is on, the external power signal S_{OP} is inputted to the dimming driving unit 20; when off, the external power signal S_{OP} cannot be inputted to the dimming driving unit 20.

As mentioned above, in the embodiment, the dimming driving unit 20 controls the light-emitting element 211 according to the frequency or the interval of receiving the external power signal S_{OP} during a specific time range, which is similar to controlling the light-emitting element 211 according to the switching frequency or the switching interval of the power switch S2 during a specific time range.

The following example illustrates how the dimming driving unit 20 controls the light-emitting element 211 to emit the light according to the switching frequency of the power switch S2 during a specific time range. When the power switch S2 switches once during a specific time range (e.g. 3 seconds), the dimming driving unit 20 outputs a driving signal S_{D} to the light-emitting element 211 for emitting the light with quarter brightness. When the power switch S2 switches twice during a specific time range, the dimming driving unit 20 outputs the driving signal S_{D} to the light-emitting element 211 for emitting the light with half brightness. When the power switch S2 switches three times during a specific time range, the dimming driving unit 20 outputs the driving signal S_{D} to the light-emitting element 211 for emitting the light with three-quarter brightness. When the power switch S2 switches four times, the dimming driving unit 20 outputs the driving signal S_{D} to the light-emitting element 211 for emitting the light with full brightness.

The above-mentioned driving signal S_{D} has different powers corresponding to different switching frequencies (or switching intervals) for driving the light-emitting element 211 to emit the light with different brightness.

FIG. 4 further discloses the dimming driving unit 20 in the embodiment. As shown in FIG. 4, the dimming driving unit 20 further includes a dimming loop 22 and a driving loop 23. The dimming loop 22 is electrically connected to the power switch S2 for receiving the external power signal S_{OP} and generates a modulating signal S_{M} according to the switching frequency or the switching interval during a specific time range.

The dimming loop 22 may include the circuit for generating the modulating signal S_{M}. For example, the dimming loop 22 may contain a rectifying circuit, a DC-DC power conversion circuit, and a control circuit. The rectifying circuit may convert the external power signal S_{OP} that is an AC signal into a DC signal. After that, the DC-DC power conversion circuit may convert the DC signal into the working voltage of the controller and the control circuit may generate the modulating signal S_{M} according to the converted signal. The modulating signal S_{M} may be a duty cycle control signal, a frequency control signal, or a voltage control signal. It may also be an analog modulating signal or a digital modulating signal. If the modulating signal S_{M} is the digital modulating signal, the dimming loop 22 may have a digital controller, which may be, for example, a microcontroller unit (MCU).

The driving loop 23 electrically connects the dimming loop 22 with the light-emitting element 211 and generates the driving signal S_{D} according to the modulating signal S_{M} for driving the light-emitting element 211 to emit the light with different brightness. A user may control the brightness of the light-emitting element 211 according to the switching frequency or the switching interval at different points of time. The modulating signals S_{M} generated in accordance with the different switching frequencies or intervals have different waveforms, such that the driving signals S_{D} generated by the modulating signals S_{M} have different powers. Therefore, the light-emitting element 211 may emit the light with different brightness for dimming.

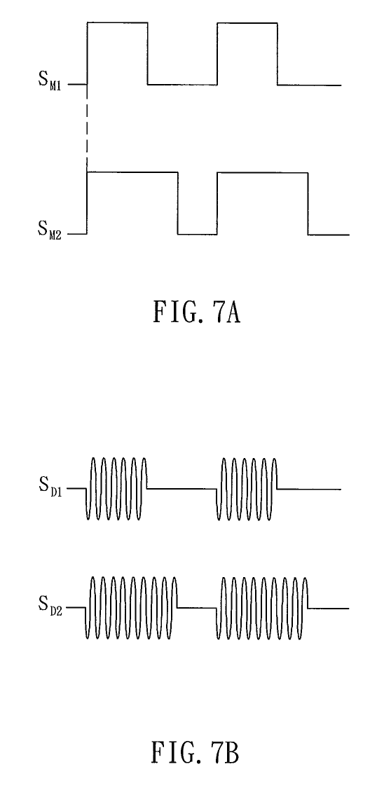

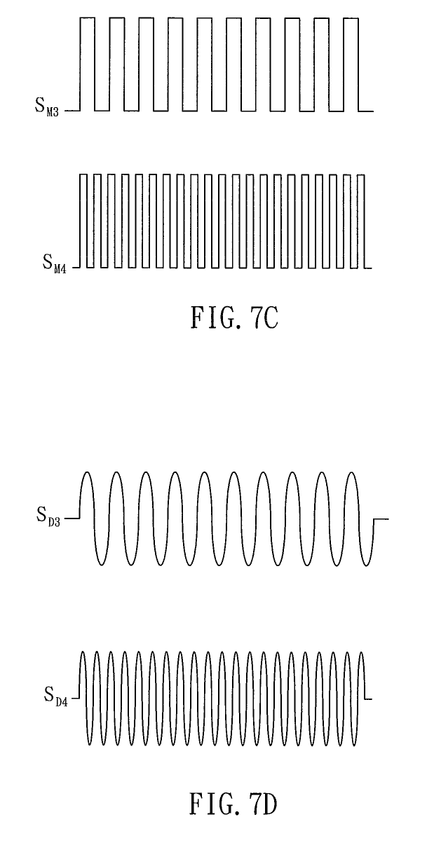

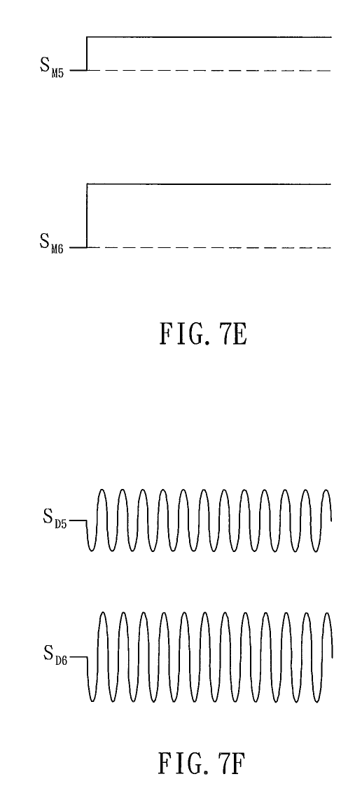

FIGS. 7A to 7F illustrate the modulating signals S_{M} and the generated driving signals S_{D} in various aspects. FIG. 7A shows that a modulating signal S_{M1} and a modulating signal S_{M2} are, for example, the duty cycle control signals. The duty cycle of the modulating signal S_{M2} is greater than that of the modulating signal S_{M1} and the driving loop 23 may generate the driving signals S_{D1} and S_{D2} shown in FIG. 7B in accordance with the modulating signals S_{M1} and S_{M2}, respectively. According to FIG. 7B, it is learned that the driving time of the driving signal S_{D2} is longer, so a larger driving power can be obtained. A larger dimming range can therefore be acquired by modulating the percentage of the duty cycle.

The modulating signals S_{M3} and S_{M4} shown in FIG. 7C are, for example, frequency controls signals. The frequency of the modulating signal S_{M4} is higher than that of the modulating signal S_{M3} and the driving loop 23 may generate the driving signals S_{D3} and S_{D4} shown in FIG. 7D in accordance with the modulating signals S_{M3} and S_{M4}, respectively. According to FIG. 7D, it is learned that the frequency of the driving signal S_{D4} is higher than that of the driving signal S_{D3}, so a larger driving power can be obtained. Furthermore, the frequency of the driving signal S_{D4} is also higher.

The modulating signals S_{M5} and S_{M6} shown in FIG. 7E are, for example, voltage control signals. The voltage level of the modulating signal S_{M6} is higher than that of the modulating signal S_{M5} and the driving loop 23 may generate the driving signals S_{D5} and S_{D6} shown in FIG. 7F in accordance with the modulating signals S_{M5} and S_{M6}, respectively. According to FIG. 7F, it is learned that the amplitude of the driving signal S_{D6} is greater than that of the driving signal S_{D5}, so a larger driving power can be obtained. It is noted that although FIGS. 7A to 7F are examples of duty cycle control, frequency control, and voltage control, at the same time, those skilled in the art may acquire the power signal with at least two of the above-mentioned control methods.

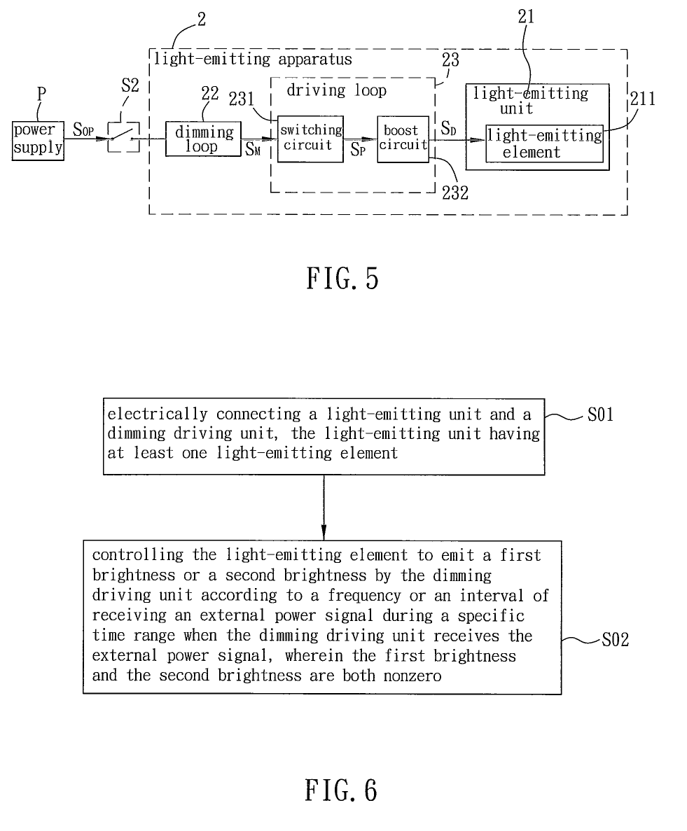

FIG. 5 further discloses the driving loop 23 in the embodiment. With reference to FIG. 5, the driving loop 23 includes a switching circuit 231 and a boost circuit 232. The switching circuit 231 is electrically connected to the dimming loop 22 and generates the power signal S_{P} according to the modulating signal S_{M}. The boost circuit 232 is electrically connected to the switching circuit 231 and outputs the driving signal S_{D} according to the power signal S_{P}.

The switching circuit 231 may include the electronic element for switching and generating the power signal S_{P} according to the modulating signal S_{M}. For example, the switching circuit 231 may include a plurality of transistors, which can switch in accordance with the modulating signal S_{M}. The boost circuit 232 may include a transformer for boosting and converting the power signal S_{P} into the driving signal S_{D}.

It is noted that in the above-mentioned embodiment, the dimming driving unit 20 controls a light-emitting element 211 for example. In the present invention, of course, the dimming driving unit 20 may also transmit the driving signal S_{D} to a plurality of light-emitting elements for individually dimming the light-emitting elements.

FIG. 6 is a flowchart of a dimming method, which comprises the steps S01 and S02. Step S01 is to electrically connect a light-emitting unit 21 and a dimming driving unit 20, in which the light-emitting unit 21 has at least one light-emitting element 211. Step S02 is to control the light-emitting element 211 to emit a first brightness or a second brightness, which are both nonzero, according to the frequency or the interval of receiving an external power signal S_{OP} during a specific time range when the dimming driving unit 20 receives the external power signal S_{OP}. At the same time, the dimming method may further include generating a modulating signal S_{M} according to the frequency or the interval of receiving the external power signal S_{OP} during a specific time range; and generating a driving signal S_{D} according to the modulating signal S_{M} for driving the light-emitting element 211. Since the dimming method has been described, a detailed description thereof is omitted herein.

To sum up, in the light-emitting apparatus and dimming method of the present invention, the dimming driving unit controls the light-emitting element to emit a first brightness or a second brightness, which are both nonzero, according to the switching frequency or the switching interval during a specific time range when the power switch is turned on. The dimming driving unit may also control the light-emitting element to emit a first brightness or a second brightness, which are both nonzero, according to the frequency or the interval of receiving an external power signal during a specific time range when the power switch receives the external power signal. Therefore, the light-emitting element may adjust the brightness of a single light-emitting element by emitting out different brightness, so as to be conveniently used and enhance product competitiveness.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting apparatus applied with a power switch, comprising:
a light-emitting unit having at least one light-emitting element; and
a dimming driving unit electrically connected to the light-emitting unit and controlling the light-emitting unit to emit a first brightness or a second brightness according to a switching frequency or a switching interval of the power switch during a specific time range when the power switch is turned on, wherein the first brightness and the second brightness are both nonzero.

2. The light-emitting apparatus according to claim 1, wherein the light-emitting element is a fluorescent lamp.

3. The light-emitting apparatus according to claim 1, wherein the light-emitting unit is spiral, linear, or in U-shape.

4. The light-emitting apparatus according to claim 1, wherein the dimming driving unit comprising:
a dimming loop generating a modulating signal according to the switching frequency or the switching interval of the power switch during the specific time range; and
a driving loop electrically connected to the dimming loop and the light-emitting unit and generating a driving signal for driving the light-emitting unit according to the modulating signal.

5. The light-emitting apparatus according to claim 4, wherein the dimming loop comprises a digital controller.

6. The light-emitting apparatus according to claim 5, wherein the digital controller is a microcontroller unit (MCU).

7. The light-emitting unit according to claim 4, wherein the modulating signal is a duty cycle signal, a frequency control signal, or a voltage control signal.

8. The light-emitting apparatus according to claim 4, wherein the modulating signal is an analog modulating signal or a digital modulating signal.

9. The light-emitting apparatus according to claim 1, wherein the power switch is electrically connected to the dimming driving unit and a power supply for switching on or off between the power supply and the dimming driving unit.

10. The light-emitting apparatus according to claim 9, wherein the power supply is an alternating current (AC) power supply or a direct current (DC) power supply.

11. A light-emitting apparatus, comprising:
a light-emitting unit having at least one light-emitting element; and
a dimming driving unit electrically connected to the light-emitting unit and controlling the light-emitting element to emit a first brightness or a second brightness according to a frequency or an interval of receiving an external power signal during a specific time range when the dimming driving unit receives the external power signal, wherein the first brightness and the second brightness are both nonzero.

12. A dimming method, comprising the steps of:
electrically connecting a light-emitting unit and a dimming driving unit, the light-emitting unit having at least one light-emitting element; and
controlling the light-emitting element to emit a first brightness or a second brightness by the dimming driving unit according to a frequency or an interval of receiving an external power signal during a specific time range when the dimming driving unit receives the external power signal, wherein the first brightness and the second brightness are both nonzero.

13. The dimming method according to claim 12, further comprising:
generating a modulating signal according to the frequency or the interval of receiving the external power signal during the specific time range; and
generating a driving signal for driving the light-emitting element according to the modulating signal.
